(19) United States
(12) Patent Application Publication
(10) Pub. No.: US 2006/0057393 A1
(43) Pub. Date: Mar. 16, 2006

(54) VOC-free polyurethane coating composition

(75) Inventors: John W. Reisch, North Kingstown, RI (US); Tracy A. Paolilli, East Greenwich, RI (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(73) Assignee: Soluol, Inc., a corporation of the State of Rhode Island

(21) Appl. No.: 10/940,300

(22) Filed: Sep. 13, 2004

(51) Int. Cl. B32B 27/40; C08G 18/00

(52) U.S. Cl. 428/423.1; 528/44

(57) ABSTRACT

This invention relates to a new two-component 100% solids polyurethane coating composition characterized by being free of volatile organic compounds (hence “VOC-free”). The coating composition is used to provide a durable coating on a substrate. The coating is produced by reacting a liquid polyester polyol with a polyfunctional isocyanate. Optionally, the polyol component contains a short chain polyol to provide hard segments in the resulting coating. The coating is particularly useful for providing a top coat on concrete form panels, such as plywood form panels, that are widely employed in the construction industry.

### BACKGROUND OF THE INVENTION

1. Field of the Invention

This invention relates to a new two-component 100% solids polyurethane coating composition characterized by being free of volatile organic compounds (hence “VOC-free”). The coating composition is used to provide a durable coating on a substrate. The coating is produced by reacting a liquid polyester polyol with a polyfunctional isocyanate. Optionally, the polyol component contains a short chain polyol to provide hard segments in the resulting coating.

Although the coating composition can be used on a wide variety of substrates, it is particularly useful for providing a top coat on concrete form panels, such as plywood form panels, that are widely employed in the construction industry.

2. Brief Description of Art

Concrete form panels are used generally as sheeting in temporary concrete formwork to mold freshly placed concrete poured into the formwork, and to retain the poured concrete until it sets and gains sufficient strength to stay in place without the forms. The formwork is thereafter removed and the panels stripped from the hardened self-supporting concrete structure.

Economy is a major concern to the concrete contractor because the formwork itself costs as much as from 35 to 70 percent of the total cost of the concrete structure. Accordingly, the more times that the concrete form panels can be reused, the lower the cost to the contractor. Therefore, it is highly desirable to the construction industry to have concrete form panels that can be reused multiple times.

Various techniques have been proposed or used in the past in an effort to improve the quality and durability of concrete form panels and reduce formwork costs. Illustratively, oils have been applied to plywood concrete form panels as release agents to facilitate easy separation of the plywood form panels from the set concrete. However, even with the use of oils, or other release agents, the plywood form panels can typically only be used for two or three concrete pours before they are damaged and must be discarded and replaced.

Another approach to improve the stripability and reuse of plywood concrete form panels is to apply various plastic coatings to the face of the plywood panel. In this respect see the related U.S. Pat. Nos. 3,240,618; 3,468,690; and 3,703,394 of Charles B. Hemming and others describing smooth coated panels said to impart to the formed concrete a very desirable gloss and velvety smooth surface without staining. Said U.S. Pat. No. 3,240,618 describes using “form oil” such as SAE 10 to 30 paraffinic type hydrocarbon oil, to impregnate the plywood and then coating it with a moisture-curable isocyanate terminated urethane prepolymer to form a porous polyurethane film adhered to the oil-coated surface. Said U.S. Pat. No. 3,468,690 describes a modification of the foregoing, wherein form oil is blended with the polymer, which can be made form Spenkel™ M86-50CX one-package moisture cured urethane coating. Said U.S. Pat. No. 3,703,394 describes the further modification of dispersing microspheric particles of polyolefinic materials in the polyurethane film, which can be applied by spraying resin and catalyst from separate spray guns mounted so that they mix at the panel surfaces.

U.S. Pat. No. 5,464,680 assigned to WorldTech Coatings, Inc. describes plastic coated plywood sheet concrete form panels wherein the coating is also derived from a moisture-curable urethane coating composition. The urethane coating composition of the '680 patent is comprised of a mixture of an isocyanate terminated urethane prepolymer formed from a first polyisocyanate allowed to react with a polyoxypropylene polyol in admixture with a second polyisocyanate having three to five isocyanate groups per molecule. Although column 5, lines 27-30 of the '680 patent states that the prepolymers useful in the invention of that patent are commercially available “as solvent-free or in solution of solvents such as butyl acetate or CELLOSOLVE acetate”, the working examples describe only organic solvent-containing compositions. The use of organic solvents poses a risk to the environment.

Thus, while the plastic coating compositions, including the above-described moisture-curable polyurethane polymers, impart the advantage of repeated reusability to plywood concrete form panels coated with these materials, and hence reduced concrete construction costs, these compositions are typically supplied in volatile organic solvents, and these solvents impart VOCs to the compositions. VOCs are a hazard to the environment. Accordingly, there is a need in the construction industry for a coating composition for providing plastic coated concrete form panels that imparts the advantage of repeated reusability without the disadvantage of containing VOCs. The present invention provides an answer to that need.

### BRIEF SUMMARY OF THE INVENTION

In one aspect, the present invention relates to a VOC-free, two-component coating composition comprising (advantageously consisting essentially of, and more advantageously consisting of) (a) a polyisocyanate, preferably an aromatic polyisocyanate, and (b) a polyester polyol having a number average molecular weight of at least 500, optionally together with a short-chain polyol. The short-chain polyol, if present, has between 2 and 40 carbon atoms, and a number average molecular weight of less than 500. The short-chain polyol enhances the hardness of the resulting coating by providing hard segments therein. The coating composition is particularly suitable for providing a topcoat for concrete form panels, such as such panels fabricated from wood, wood products, or metals such as steel.

In another aspect, the present invention relates to a substrate coated with a coating composition comprising (advantageously consisting essentially of, and more advantageously consisting of) (A) a polyisocyanate, preferably an aromatic polyisocyanate, and (B) a polyester polyol, optionally in admixture with a short-chain polyol having between 2 and 40 carbon atoms. The short-chain polyol, if present, enhances the hardness of the resulting coating by providing hard segments therein. The coated substrate can comprise, for example, a topcoat for concrete form panels, or a topcoat for wooden floors or walls.

In yet another aspect, the present invention relates to a method for making a polyurethane-coated concrete form panel which comprises the steps of: (1) reacting in a solvent-free environment (A) a polyisocyanate and (B) a polyester polyol having a molecular weight of at least 500 daltons, optionally in admixture with a short chain polyol having between 2 and 40 carbon atoms and a molecular weight of less than 500 daltons, to form a VOC-free coating composition, and (2) coating at least one outer surface of a concrete form panel fabricated of wood, fiberboard, plastic, metal (such as iron, steel or tin), and combinations thereof, with said coating composition to provide said polyurethane-coated concrete form panel.

These and other aspects will become apparent upon reading the following detailed description of the invention.

### DETAILED DESCRIPTION OF THE INVENTION

It has now been surprisingly found in accordance with the present invention that a 100% solids two-component (2-K) coating composition is suitably provided for coating substrates in an organic solvent-free environment. This coating composition is environmentally-friendly since the composition is entirely free of Volatile Organic Compounds (so-called “VOCs”). When the coated substrates are concrete form panels, the coated panels can be used and re-used numerous times in the construction industry in building concrete structures.

The polyfunctional polyisocyanate of Part A of the composition of the present invention may be an aromatic polyisocyanate such as polymeric diphenyl methane diisocyanate (PMDI). Polymeric MDI is commercially available as: Papi® 27 (Dow Chemical), Mondur® MR (Bayer), Lupranate® M-20S (BASF), Rubinate® M (Huntsman). Alternatively the polymeric polyisocyanate of part A may be an aliphatic polyisocyanate, such as hexamethylene diisocyanate trimer such a Desmodur® 3300 (Bayer) or Tolonate® HDT (Rhodia), or hexamethylene diisocyanate biuret, available commercially as Desmodur® N-100 or Tolonate® HDB (Rhodia). Because of their lower cost, the aromatic polyisocyanates are preferred.

The polyester polyols of Part B of the composition of the present invention may be produced by reacting a dicarboxylic acid such as adipic acid, phthalic acid, isophthalic acid or combinations thereof, or the like, with one or more short chain polyols. Useful short chain polyols include, but are not limited to, 1,4-butane diol, ethylene glycol, diethylene glycol, 1,3-propylene glycol, dipropylene glycol, 2-methyl-1,3-propane diol (MPdiol), 1,5-pentane diol, 1,6-hexane diol, tripropylene glycol, neopentyl glycol, or the like. Any desired molecular weight for the polyester polyol can be provided by varying the amount of the dicarboxylic acid relative to the amount of the short chain polyol. Suitable molar ratios of dicarboxylic acid to short chain polyol range from 1:1.1 to 1:2.5 for producing the polyester polyol. Useful polyester polyols include those having number average molecular weights within the range of from 500 to 4000 daltons may be used. Preferred polyester polyol molecular weights are between 500 and 2000 daltons.

Optionally, the polyester polyol of Part B may be blended with a short chain polyol having a molecular weight of less than 500, such as but not limited to 1,4-butane diol, ethylene glycol, diethylene glycol, 1,3-propylene glycol, dipropylene glycol, 2-methyl-1,3-propane diol (MPdiol), 1,5-pentane diol, 1,6-hexane diol, tripropylene glycol, neopentyl glycol, polyether quadrol such as Poly-G 540-450, or the like. The reaction of the short chain polyol with the polyfunctional isocyanate creates hard segments in the film. The higher the amount of hard segments the harder the film. The hardness of the coating may be increased by decreasing the molecular weight of the polyester polyol and or blending increasing amounts of short chain polyol with the polyester polyol.

The reaction of the polyols with the polyfunctional polyisocyanate can be catalyzed with a wide variety of catalysts. Tin catalysts such as dibutyltin dilaurate, dibutyltin diacetate, or stannous octoate, amine catalysts such as triethylene diamine or zirconium or bismuth catalysts can all be used.

The present invention is further described in detail by means of the following Examples and Comparisons. All parts and percentages are by weight and all temperatures are degrees Celsius unless explicitly stated otherwise.

### EXAMPLES

Five ply yellow Meranti plywood panels were coated with a basecoat filler composed of an acrylic emulsion filled with calcium carbonate and pigmented with a yellow iron oxide pigment. Thus 120 parts of acrylic emulsion 4790 (Daicel Chemical Co.) was mixed with 180 parts of calcium carbonate Vicron 31-6 (Specialty Minerals Inc.) and 12 parts of Colanyl Oxide Yellow (Clariant). The mixture was coated on plywood panels with a paintbrush and then drawn down with a large squeegee to form a smooth basecoat. The plywood panels were dried in an oven at 70 C for 15 minutes. The base coated panels were then coated with the new 100% solids topcoat of the present invention.

Preparation of a Liquid Polyester Polyol:

Polyester 1: A 1000 molecular weight polyester polyol was prepared from the reaction of adipic acid with diethylene glycol. Thus 495.5 grams of adipic acid and 504.5 grams of diethylene glycol were charged to a resin kettle with mixer. The mixture was heated to 220° C. and water formed from the condensation reaction was removed with a Dean Stark trap. After heating for 5 hours at 220° C. the water condensation stopped. The acid number of the polyester polyol was measured and it was found to be 0.73. The hydroxyl number was measured and it was found to be 110. The polyester polyol formed from this reaction was liquid at room temperature.

Polyester 2: A 2000 molecular weight polyester polyol was prepared from the reaction of adipic acid with diethylene glycol. Thus 542 grams of adipic acid and 458 grams of diethylene glycol were charged to a resin kettle with mixer. The mixture was heated to 220° C. and water formed from the condensation reaction was removed with a Dean Stark trap. After heating for 5 hours at 220° C. the water condensation stopped. The acid number of the polyester polyol was measured and it was found to be 0.87. The hydroxyl number was measured and it was found to be 55. The polyester polyol formed from this reaction was liquid at room temperature.

Polyester 3: A 1000 molecular weight polyester polyol was prepared from the reaction of adipic acid with 2-methyl-1,3-propane diol. Thus 544 grams of adipic acid and 455 grams of 2-methyl-1,3-propane diol were charged to a resin kettle with mixer. The mixture was heated to 220° C. and water formed from the condensation reaction was removed with a Dean Stark trap. After heating for 5 hours at 220° C. the water condensation stopped. The acid number of the polyester polyol was measured and it was found to be 0.8. The hydroxyl number was measured and it was found to be 112. The polyester polyol formed from this reaction was liquid at room temperature.

Polyester 4: In a similar manner a 2000 molecular weight polyester polyol was prepared from the reaction of adipic acid and 2-methyl-1,3-propane diol. Thus 578 grams of adipic acid and 421 grams of 2-methyl-1,3-propane diol were charged to a resin kettle with mixer. The mixture was heated to 220° C. and water formed from the condensation reaction was removed with a Dean Stark trap. After heating for 5 hours at 220° C. the water condensation stopped. The acid number of the polyester polyol was measured and it was found to be 0.65. The hydroxyl number was measured and it was found to be 55. The polyester polyol formed from this reaction was liquid at room temperature.

Preparation of 100% Solids Topcoats for Plywood form Panels:

Topcoat 1: Polyester 1 diethylene glycol adipate 50 parts was mixed with polymeric diphenylmethane diisocyanate (Papi® 27—Dow Chemical) 16.95 parts and dibutyltin dilaurate catalyst (Air Products) 0.2 parts. The mixture was coated on the basecoated plywood panels with a paint brush then drawn down with a squeegee to form a thin even coat. The coated panel was cured in an oven at 70 C for 15 minutes.

Topcoat 2: Polyester 2 diethylene glycol adipate 50 parts was mixed with polymeric diphenylmethane diisocyanate (Mondur® MR—Bayer) 7 parts and dibutyltin dilaurate catalyst 0.2 parts. The mixture was coated on the base coated plywood panels with a paint brush then drawn down with a squeegee to form a thin even coat. The coated panel was cured in an oven at 70° C. for 15 minutes.

Topcoat 3: Polyester 1 diethylene glycol adipate 50 parts was blended with 50 parts of a four functional polyether polyol (Poly-G® 540-450, Arch Chemicals, Inc.) and then mixed with 73 parts of polymeric diphenylmethane diisocyanate (Papi® 27—Dow Chemical) and Dabco® NCM amine catalyst (Air Products) 2.8 parts. The mixture was coated on the base coated plywood panels with a paint brush then drawn down with a squeegee to form a thin even coat. The coated panel was cured in an oven at 70 C for 15 minutes.

Topcoat 4: Polyester 3 MP diol adipate 50 parts was blended with 1,4-butane diol 5 parts and then mixed with 32 parts of polymeric diphenylmethane diisocyanate (Lupranate® M-20S—BASF) and Dabco® NCM amine catalyst 0.86 parts. The mixture was coated on the base coated plywood panels with a paint brush then drawn down with a squeegee to form a thin even coat. The coated panel was cured in an oven at 70° C. for 15 minutes.

Topcoat 4 was coated on glass and the Konig hardness was measured according to ASTM D4366. The Konig hardness was found to be 77. The instrument to measure Konig hardness consists of a pendulum which is free to swing on two balls resting on a coated test panel. The pendulum hardness test is based on the principle that the amplitude of the pendulum's oscillation will decrease more quickly when supported on a softer surface. The hardness of any given coating is given by the number of oscillations made by the pendulum within the specified limits of amplitude determined by accurately positioned photo sensors. An electronic counter records the number of swings made by the pendulum. A transparent acrylic case excludes drafts. Standard hardness tests relate oscillation damping to surface hardness. The Konig test for hard coatings measures the time taken for the amplitude to decrease from 6° to 3°. The Konig pendulum is triangular with an adjustable counterpoise and swings on two ball bearings of 5 mm diameter which rest on the test surface. The counterpoise is used to adjust the period of oscillation to the specified 1.4 seconds.

Topcoat 5: Polyester 3 MP diol adipate 50 parts was blended with 1,4-butane diol 10 parts and then mixed with 48 parts of polymeric diphenylmethane diisocyanate (Papi® 27—Dow Chemical) and Dabco® 33LV(Air Products) amine catalyst 0.86 parts. The mixture was coated on the base coated plywood panels with a paint brush then drawn down with a squeegee to form a thin even coat. The coated panel was cured in an oven at 70 C for 15 minutes.

Topcoat 5 was coated on glass and the Konig hardness was measured and found to have a hardness value of 95.

Topcoat 6: Polyester 4 MP diol adipate 50 parts was blended with 1,4-butane diol 10 parts and then mixed with 40 parts of polymeric diphenylmethane diisocyanate (Lupranate® M-20S—BASF) and KCat XCA 209 (King Industries) zirconium catalyst 0.10 parts. The mixture was coated on the base coated plywood panels with a paint brush then drawn down with a squeegee to form a thin even coat. The coated panel was cured in an oven at 70° C. for 15 minutes.

Concrete pour tests: One foot square panels coated with the basecoat filler described above and the new 100% solids topcoats 1 through 6 described above were fitted with 3 inch wood spacers and concrete was poured between the panels. The concrete was allowed to cure for 72 hours and then the panels were removed. The panels were easily removed from the concrete and the concrete had a smooth surface.

Field test: Three foot by six foot plywood panels were coated with the basecoat filler described above and then with Topcoat 4 described above. The panels were tested according to methods described in the Japanese Agricultural Standard (as more fully described in JAS Notification No. 852 of the Japanese Ministry of Agriculture, Forestry and Fisheries, Jun. 21, 1999). Several different base panels were tested having coating weights as described below. The following JSA tests were conducted: (a) flat plane tensile test (also called the “flatwise tensile strength test”), (b) the cyclic high low temperature test (also called the “cyclic low/high temperature weathering test”, and (c) the alkali resistance test. JSA collectively refers to these tests as “cyclic boiling and other tests”. The following test results were obtained:

Reference Numbers Corresponding to Tested Base Panels

| Number | Base Panel |
|---|---|
| 1 | Yellow Meranti Basecoat 109 grams/panel; |
| | Topcoat Four - 51 grams/panel |
| 2 | Kamerere Basecoat 113 grams/panel; |
| | Topcoat Four - 81 grams/panel |
| 3 | Kapor Basecoat 98 grams/panel; |
| | Topcoat Four - 52 grams/panel |

(a) Flat Plane Tensile Test (N/mm2)
JAS Standard (more than 1.0 N/mm2)

| Number | 1 | 2 | 3 | 4 | Average | Result |
|---|---|---|---|---|---|---|
| 1 | 1.5 | 1.5 | 2.0 | 1.3 | 1.6 | PASSED |
| 2 | 1.3 | 1.5 | 1.5 | 1.4 | 1.4 | PASSED |
| 3 | 1.0 | 1.4 | 1.4 | 1.7 | 1.1 | PASSED |

(b) Cyclic High and Low Temperature Test

| Number | | Result |
|---|---|---|
| 1 | No change | PASSED |
| 2 | No change | PASSED |
| 3 | No change | PASSED |

(c) Alkali Resistance Test

| Number | | Result |
|---|---|---|
| 1 | No change | PASSED |
| 2 | No change | PASSED |
| 3 | No change | PASSED |

The 3 foot by 6 foot coated plywood panels on the Yellow Meranti plywood were tested at a construction site. Concrete was poured between the panels and allowed to cure for three days. The panels were removed from the concrete and they removed easily. The process was repeated for 5 pours of concrete. The panels remained in good shape with no cracking or peeling of the coating and the panels were easily removed from the concrete.

While the invention has been described above with reference to specific embodiments thereof, it is apparent that many changes, modifications, and variations can be made without departing from the inventive concept disclosed herein. Accordingly, it is intended to embrace all such changes, modifications and variations that fall within the spirit and broad scope of the appended claims. All patent applications, patents and other publications cited herein are incorporated by reference in their entirety.

What is claimed is:

1. A VOC-free polyurethane coating composition comprising
(A) a polyisocyanate and
(B) a polyester polyol having a molecular weight of at least 500 daltons, optionally in admixture with a short chain polyol having between 2 and 40 carbon atoms and a molecular weight of less than 500 daltons.

2. The coating composition of claim 1 which consists essentially of said components (A) and (B) in a molar ratio of between 1:0.6 and 0.8:1.

3. The coating composition of claim 1 wherein wherein said component (A) consists essentially of an aromatic polyisocyanate and said (B) component consists essentially of a polyester polyol having a molecular weight of between 500 and 4000 daltons in admixture with a short chain polyol selected from the group consisting of 1,4-butane diol, ethylene glycol, diethylene glycol, 1,3-propylene glycol, dipropylene glycol, 2-methyl-1,3-propane diol, 1,5-pentane diol, 1,6-hexane diol, tripropylene glycol, neopentyl glycol, polyether quadrol, and combinations thereof.

4. A substrate coated with a coating composition comprising:
(A) a polyisocyanate, and
(B) a polyester polyol, optionally in admixture with a short-chain polyol having between 2 and 40 carbon atoms.

5. The substrate of claim 4 wherein the polyisocyanate is an aromatic polyisocyanate.

6. The substrate of claim 4 wherein the polyisocyanate is polymeric MDI.

7. The substrate of claim 4 which is fabricated of wood or a wood product.

8. The substrate of claim 4 which is fabricate of metal.

9. The substrate of claim 8 wherein the metal is selected from the group consisting of iron, steel, tin and combinations thereof.

10. A polyurethane-coated concrete form panel comprising a concrete form panel fabricated of wood, fiberboard, plastic, metal, and combinations thereof, said form panel being coated on at least one outer surface thereof with a VOC-free polyurethane coating comprising the reaction product of: (A) a polyisocyanate and (B) a polyester polyol having a molecular weight of at least 500 daltons, optionally in admixture with a short chain polyol having between 2 and 40 carbon atoms, and a molecular weight of less than 500 daltons.

11. The concrete form panel of claim 10 which is fabricated of plywood and wherein said polyurethane coating has a Konig hardness of between 40 and 140 as measured by ASTM test number D4366-95 12. The concrete form panel of claim 11 wherein the Konig hardness is between 60 and 100.

13. A method for making a polyurethane-coated concrete form panel which comprises the steps of:
(1) reacting in a solvent-free environment (A) a polyisocyanate and (B) a polyester polyol having a molecular weight of at least 500 daltons, optionally in admixture with a short chain polyol having between 2 and 20 carbon atoms and a molecular weight of less than 500, to form a VOC-free coating composition, and
(2) coating at least one outer surface of a concrete form panel fabricated of wood, fiberboard, plastic, metal, and combinations thereof, with said coating composition to provide said polyurethane-coated concrete form panel.
